(19) United States
(12) Patent Application Publication
(10) Pub. No.: US 2013/0201098 A1
(43) Pub. Date: Aug. 8, 2013

(54) ADJUSTMENT OF A PARAMETER USING COMPUTING DEVICE MOVEMENT

(71) Applicants: William Noah Schilit, Mountain View, CA (US); Roy Want, Los Altos, CA (US)

(72) Inventors: William Noah Schilit, Mountain View, CA (US); Roy Want, Los Altos, CA (US)

(73) Assignee: GOOGLE INC., Mountain View, CA (US)

(21) Appl. No.: 13/612,308

(22) Filed: Sep. 12, 2012

Related U.S. Application Data
(60) Provisional application No. 61/594,239, filed on Feb. 2, 2012.

(51) Int. Cl. G09G 5/00

(52) U.S. Cl. 345/156

(57) ABSTRACT

In general, techniques and systems for controlling a parameter of a target device are described. In one example, a method includes obtaining, by a computing device, control information from an identification device that is associated with a target device, wherein the control information identifies the target device and a parameter that at least partially defines operation of the target device. The method may also include detecting, by at least one sensor of the computing device, physical movement of the computing device subsequent to obtaining the control information and transmitting the control information and movement information to a networked device configured to adjust a value of the parameter of the target device based at least in part on a function of the movement information. The movement information may include information that indicates the detected physical movement.

This application claims the benefit of U.S. Provisional Application No. 61/594,239, filed Feb. 2, 2012, the entire content of each of which is incorporated herein by reference.

### TECHNICAL FIELD

This disclosure relates to controlling a parameter of a target device using a computing device.

### BACKGROUND

A user may interact with applications executing on a computing device. For instance, a user may install, view, or delete an application on a computing device.

In some instances, a user may use a mobile computing device (e.g., mobile phone, tablet computer, smart phone, or the like) to communicate with other devices or systems. For instance, a user may transmit information from the mobile computing device to a remote computing device.

### SUMMARY

In one example, a method includes obtaining, by a computing device, control information from an identification device that is associated with a target device, wherein the control information identifies the target device and a parameter that at least partially defines operation of the target device, detecting, with at least one sensor of the computing device, physical movement of the computing device subsequent to obtaining the control information, and transmitting the control information and movement information to a networked device configured to adjust a value of the parameter of the target device based at least in part on a function of the movement information, wherein the movement information comprises information that indicates the detected physical movement.

In another example, a computer-readable storage medium is encoded with instructions that cause one or more processors of a computing device to perform operations including obtain control information from an identification device that is associated with a target device, wherein the control information identifies the target device and a parameter that at least partially defines operation of the target device, detect physical movement of the computing device subsequent to obtaining the control information, and transmit the control information and movement information to a networked device configured to adjust a value of the parameter of the target device based at least in part on a function of the movement information, wherein the movement information comprises information that indicates the detected physical movement.

In another example, a computing device includes a near-field communication module configured to obtain control information from an identification device that is associated with a target device, wherein the control information identifies the target device and a parameter that at least partially defines operation of the target device, a sensor configured to detect physical movement of the computing device subsequent to obtaining the control information, and at least one processor configured to transmit the control information and movement information to a networked device configured to adjust a value of the parameter of the target device based at least in part on a function of the movement information, wherein the movement information comprises information that indicates the detected physical movement.

The details of one or more aspects of this disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device that is configured to receive control information obtained from an identification device to control a target device, in accordance with one or more aspects of the present disclosure.

FIG. 2 is a block diagram illustrating components of one example of the computing device shown in FIG. 1, in accordance with one or more aspects of the present disclosure.

FIG. 3 is a conceptual diagram illustrating an example of rotational movement of a computing device to adjust a parameter of a target device.

FIG. 4 is a conceptual diagram illustrating an example of linear movement of a computing device to adjust a parameter of a target device.

FIG. 5 is an illustration of an example user interface containing parameter information received based on control information obtained from an identification device and physical movement of the computing device.

FIG. 6 is a flow diagram illustrating an example process that may be performed by a computing device to adjust a parameter based on control information from an identification device and detected movement of the computing device.

FIG. 7 is a flow diagram illustrating an example process that may be performed by a remote server to adjust a parameter of a target device based on control information and movement information received from a computing device.

### DETAILED DESCRIPTION

In general, this disclosure is directed to techniques for controlling a target device using physical movements of a computing device. Typically, a target device (e.g., an entertainment system or room lighting control system) may be controlled using one or more controllers (e.g., an analog dial or digital remote) that adjust one or more control parameters of the target device (e.g., volume, channel, source, or lighting level). However, wired controllers require wires to be mounted between the controller and the target device, and wireless controllers still require a power cable or other battery power source. Due to these example constraints, conventional controllers may be inconvenient or impossible to install at certain desired locations within a room, building, or other space.

Techniques of this disclosure may, in various instances, enable a computing device (e.g., a mobile device) to obtain information from an identification device (e.g., a passive near-field communication device or a visual barcode) to control a parameter of a target device. In other words, the identification device may be a sticker, tag, or other device configured to be placed in almost any location desired by a user. The identification device may not require a power source and may thus be disposed on a variety of surfaces within a room or building (e.g., walls, windows, or furniture). In addition, the computing device may be simply placed within close proximity to the identification device to automatically initiate control of the parameter without navigating menus of the computing device. In other examples, however, the computing device may request confirmation from the user to start controlling the parameter of the identification device.

An information device may be labeled to visually identify the target device and/or the parameter to allow the user of the computing device to select the appropriate identification device for the desired parameter. The computing device may obtain control information from the identification device using near-field communication (NFC) or optical sensors, for example. The control information may identify a target device and a parameter that at least partially defines operation of the target device. The computing device may then transmit the control information to a networked device (e.g., a remote server) configured to communicate with the target device and adjust the parameter of the target device. The remote server may, in some examples, communicate with the target device via a network.

The identified parameter may then be adjusted based on a physical movement (e.g., a rotational tilt or linear distance moved) of the computing device. This physical movement may be a movement in space (e.g., movement with respect to the Earth and/or the user). A sensor within the computing device may detect the physical movement, and the computing device may then transmit the detected movement to the remote server via the network. The networked device may calibrate the detected movement and adjust the parameter of the target device accordingly. The remote server may then transmit the adjusted parameter to the target device and, in some examples, back to the computing device for presentation to the user.

The physical movement may be detected by measuring the orientation of the computing device with respect to gravity or earth's magnetic field, measuring the angular acceleration of the computing device, or measuring linear accelerations of the computing device, to name a few examples. In this manner, the computing device may be held in the hand of the user and moved to adjust the parameter of the target device. As two examples, the user may rotate the computing device like an analog dial or move the computing device in a linear direction like a slider. Whenever the computing device can obtain control information for a desired parameter from an identification device, the computing device may thus be used as a virtual controller for the parameter of the target device.

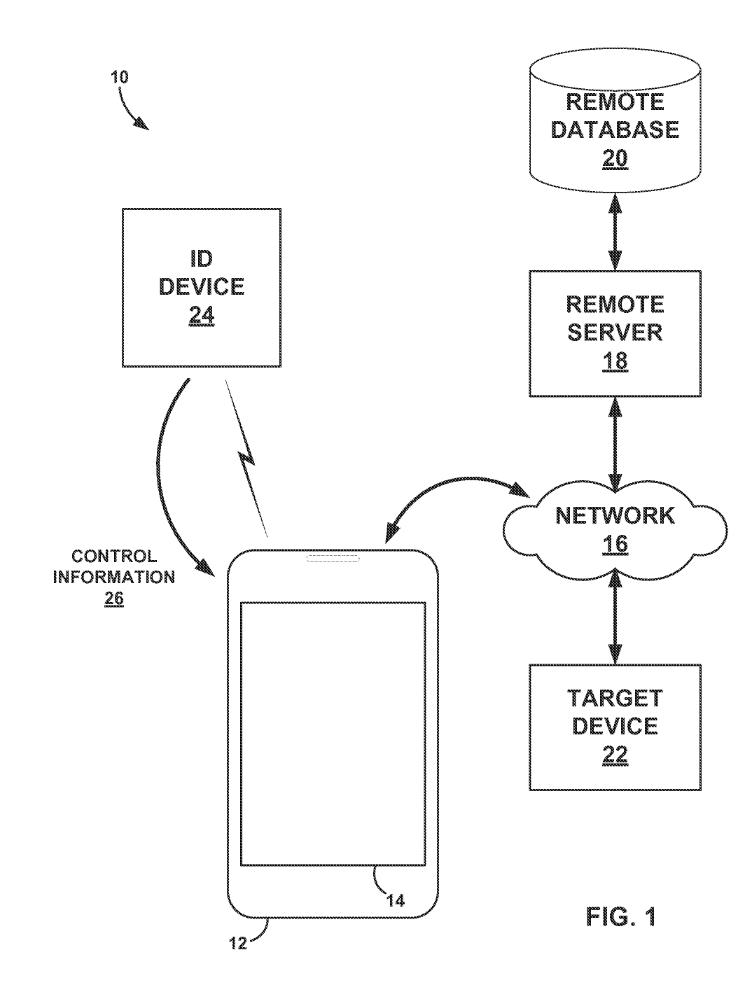

FIG. 1 is a conceptual diagram illustrating example computing device 12 that is configured to receive control information 26 obtained from identification device 24 to control target device 22. As shown in FIG. 1, system 10 includes computing device 12, target device 22, identification device 24, network 16, remote server 18, and remote database 20. Computing device 12, in some examples, is or is a part of a portable computing device (e.g., a mobile phone, a smart phone, a personal digital assistant (PDA), a netbook, a notebook, an e-reader, or a tablet device). In other examples, computing device 12 may be at least a part of a digital camera, a music player, or any other device that a user may carry or move between different locations. Computing device 12 may also connect to network 16 (a wired or wireless network).

Computing device 12 may include a short-range communication module (not shown) capable of initiating wireless communication with identification device 24, over a relatively short distance. For example, this short distance may be less than approximately 10 meters, less than 1 meter, less than 10 centimeters, or even less than 2.5 centimeters. In some examples, computing device 12 may initiate communication with identification device 24 when computing device 12 is within 5 centimeters of the identification device. In this example, a user may place computing device 12 directly over or even touching identification device 24 such that computing device 12 may communicate with the identification device at that particular location of computing device 12. The short distance required for short-range communication may be selected based on the application of identification devices 24. In other words, shorter distances may be used when identification devices are closer together to so that each of the identification devices may be uniquely distinguishable from each other. In addition, the user may benefit from being aware that control information 26 may be obtained from an identification device 24. For example, computing device 12 may request that the user confirm that short-range communication is to occur (e.g., receive a confirmation input).

In some examples, computing device 12 may be moved from identification device 24 to communicate with a different identification device that may represent a different parameter for target device 22. Although identification device 24 is generally described herein as a short-range communication device (e.g., a near-field communication device), identification device 24 may provide control information 26 in alternative mediums. For example, identification device 24 may be a visual indicator (e.g., an optical tag) such as a bar code, a Quick Response (QR) code, or a circular bar code (e.g., a ShotCode). Alternative optical tags may include a DataMatrix tag, an Aztec code, an EZcode, a High Capacity Color Barcode (HCCB), or a MaxiCode. Computing device 12 may then utilize a camera or other such sensor to obtain control information 26 from identification device 24 in the form of a graphic or other visual indicator.

As shown in FIG. 1, identification device 24 may be any device that is placed in a location at which computing device 12 may obtain control information 26. For example, identification device 24 may be placed, adhered, or otherwise attached to a wall, window, furniture, device associated with target device 22. Identification device 24 may have information associated with the parameter and/or target device 22 printed on a surface of the identification device. Alternatively, information may be printed on a sticker or other media that is attached to identification device 24. Although identification device 24 may be provided alone, identification device 24 may be provided with one or more additional identification devices that each provide control information regarding different parameters that control target device 22. Since each identification device 24 may be relatively simple and configured to communicate with any number of computing devices, computing device 12 may be capable of establishing communication with hundreds, thousands, or even millions of different identification devices. In addition, identification device 24 may provide control information 26 to two or more different computing devices 12.

As described herein, identification device 24 may be capable of short-range communication. One example of short-range communication is near-field communication (NFC). NFC communication can occur between two devices in different modes. For example, computing device 12 may operate in at least two different modes to communicate with identification device 24 using NFC. For example, computing device 12 and identification device 24 may be configured to operate in a passive mode and an active mode of operation. In an active mode of operation, computing device 12 may generate a first alternating magnetic field that is received by one of identification device 24 in physical proximity to computing device 12. In response, identification device 24 may generate a second alternating magnetic field that is received by computing device 12. In this way, data may be communicated between computing device 12 and identification device 24 such as using peer-to-peer communication. In the active mode, computing device 12 may also power or activate a passive device to retrieve data from the passive device, as further described below. In this manner, identification device 24 may include passive near field communication hardware.

In a passive mode of operation, load modulation techniques may be employed to facilitate data communication between computing device 12 and identification device 24. In a passive mode, identification device 24 does not actively generate an alternating magnetic field in response to the alternating magnetic field of computing device 12, but only as a result of the induced voltage and applied load at the receiver or antenna of identification device 24. Instead, identification device 24 may include electrical hardware (e.g., an NFC module) that generates a change in impedance in response to the alternating magnetic field generated by computing device 12. For example, computing device 12 may generate an alternating magnetic field that is received by identification device 24. Electrical hardware in identification device 24 may generate a change in impedance in response to the alternating magnetic field. The change in impedance may be detected by the NFC module of computing device 12. In this way, load modulation techniques may be used by computing device 12 to obtain control information 26 from each of identification device 24. In other words, computing device 12 may obtain control information 26 from identification device 24, but identification device 24 would not receive any data from computing device 12 in the passive mode. Other well-known modulation techniques including phase modulation and/or amplitude modulation of the applied signal resulting from load modulation may also be employed to facilitate data communication between computing device 12 and identification device 24 in other examples.

Generally, identification device 24 may operate in passive mode for NFC communication. In passive mode, identification device 24 may be referred to as NFC tags or NFC targets. In other words, computing device 12 may include active NFC hardware and identification device 24 may include passive NFC hardware. Since a passive identification device 24 do not need a dedicated power supply, identification device 24 may be placed in a variety of locations, on any surface, or even as part of smaller items. For example, identification device 24 may be embodied as a sticker or adhesive tag that is placed on the wall of a room, a window, a countertop, furniture, or any other surface. In addition, identification device 24 may also be placed behind certain surfaces in some examples. Passive identification device 24 may also be less expensive and more difficult to corrupt with computing device 12. In this manner, identification device 24 may include electrical hardware that generates a change in impedance in response to an alternating magnetic field. However, identification device 24 may be another computing device in other examples. For example, identification device 24 may each be a computing device that operates in a passive NFC mode and/or an active NFC mode. In other words, identification device 24 may include active NFC hardware in other examples. This active NFC hardware may be configured to emulate passive NFC hardware or participate in active near-field communication.

In an example of a passive identification device 24, identification device 24 may deliver control information 26 to computing device 12 in response to receiving an alternating magnetic field generated by the NFC module of computing device 12. In other words, control information 26 may be data stored on identification device 24. Upon receiving the alternating magnetic field (e.g., receiving power sufficient to transmit data) computing device 12 may receive control information 26. In this manner, identification device 24 may only be capable of delivering or sending control information 26 when computing device 12 is within close physical proximity to each respective identification device 24. Although the user may physically touch, bump, or tap computing device 12 to identification device 24, computing device 12 may be capable of receiving control information 26 from identification device 24 without physically touching identification device 24.

Control information 26 may include any information related to controlling the operation of target device 22. For example, control information 26 may include information identifying target device 22 and a parameter that at least partially controls the operation of target device 22. In some examples, control information 26 may identify two or more parameters for controlling at least a portion of target device 22. Different physical movements may control the adjustment of the values of respective identified parameters. In another example, control information 26 may merely include information identifying the parameter of target device 22 such that remote database 20 stores an association between the parameter and the appropriate target device 22. Control information 26 may, in other examples, provide additional information related to the location of identification device 24, the location of target device 22, maximum and minimum values for the identified parameter, or any other information related to adjusting a parameter of target device 22 with computing device 12.

Control information 26 may be in the form of a uniform resource locator (URL) that includes a domain associated with identification device 24 and/or target device 22 and an identifier for the specific parameter that will be adjusted by movement of computing device 12, for example. An example URL may include the domain of remote server 18, a destination of the service that controls target device 22, an identifier of the specific target control device 22, and an identifier of the parameter to at least partially control target device 22. This example URL may take the form of: “http://www.domain.com/homecontrol/targetdevice12345/volume.” The “domain” may be the domain of remote server 18, “homecontrol” may be the name of the web-based service that controls target device 22, and “targetdevice12345” may be the identifier of the specific target device 22 that will be controlled. The identifier “volume” may indicate that computing device 12 will be adjusting the value of the volume parameter. These identifiers may be different for different target devices and parameters such that each URL for unique parameters is also unique. Computing device 12 may transmit movement information in the form of data generated by moving computing device 12 in space. In some examples, this data may be transmitted as data directly to remote server 18. In other examples, the movement information may be in the form of accelerometer output values, or changes to sensor output, added to the end of the URL of control information 26.

In other examples, control information 26 may merely include a unique identifier that is unique to identification device 24. Remote database 20 may store an association between the unique identifier and any information that allows computing device 12 to control target device 22 (e.g., information that identifies target device 22 and the parameter). In this manner, control information 26 may not include information directly identifying target device 22 and the parameter.

Control information 26 may be stored in a memory or other circuit of identification device 24 (or printed in the form of a visual indication) by the user of computing device 12, the user of target device 22, or by a manufacturer or professional with knowledge of target device 22. For example, the user may purchase identification device 24, or multiple identification devices 24, with control information 26 pre-stored on identification device 24. Identification device 24 with pre-stored control information 26 may be purchased with target device 22. Identification device 24 may thus be packaged with target device 22 and configured with control information 26 from the manufacturer. Alternatively, a distributor, salesperson, or technician may write control information 26 to identification device 24 (e.g., via NFC) or otherwise configured or print identification device 24 such that computing device 12 may obtain control information 26 from identification device 24. In other examples, computing device 12 or a different computing device may be used by a user to store control information 26 onto identification device 24. Control information 26 may be downloaded from remote server 18 or another networked device via network 16. Alternatively, computing device 12 may generate control information 26 based on input from the user or information received from target device 22.

Generally, computing device 12 may transmit control information 26 to remote server 18 via network 16 upon obtaining or otherwise receiving control information 26 from identification device 24. In this manner, computing device 12 may not interpret or otherwise utilize control information 26 directly. Instead, remote server 18 may interpret control information 26 and use movement information transmitted from computing device 12 to adjust the parameter of target device 22. Remote server 18 may also transmit the adjusted parameter or any other information related to control information 26, the parameter, or target device 22 to computing device 12.

However, in some examples, computing device 12 may be configured to interpret control information 26 such that computing device 12 may present information associated with control information 26 to the user via user interface 14. In this example, computing device 12 may not require remote server 18 to present one or more pieces of information from control information 26. For example, user interface 14 of computing device 12 may present an identification of target device 22, the parameter, and/or the web-based service associated with remote server 18. In addition, control information 26 may include one or more commands interpretable by one or more processors of computing device 12. For example, one command may instruct a processor to transmit control information 26 to remote server 18. Another command may instruct a processor to open and/or execute an application associated with control of the parameter of control information 26. The application may manage communication between computing device 12 and remote server 18, manage the detection of physical movement of computing device 12, and/or control the presentation of information related to the adjustment of the parameter via user interface 14.

Once computing device 12 obtains control information 26 from identification device 24, computing device 12 may transmit control information 26 to remote server 18 using network 16. Network 16 may be any wired or wireless network that allows computing device 12 to access another computing device and/or the Internet. For example, computing device 12 may connect to network 16 to transmit control information 26 to remote server 18. Remote server 18 may then access remote database 20 to identify the particular target device 22 (e.g., an Internet Protocol address or other communication information) and the particular parameter identified by control information 26. Remote server 18 may then transmit, via network 16, parameter information to computing device 12 (e.g., the type of parameter, a name of target device 22, and the current value of the parameter) and/or initiate communication with target device 22 in anticipation of adjusting the identified parameter.

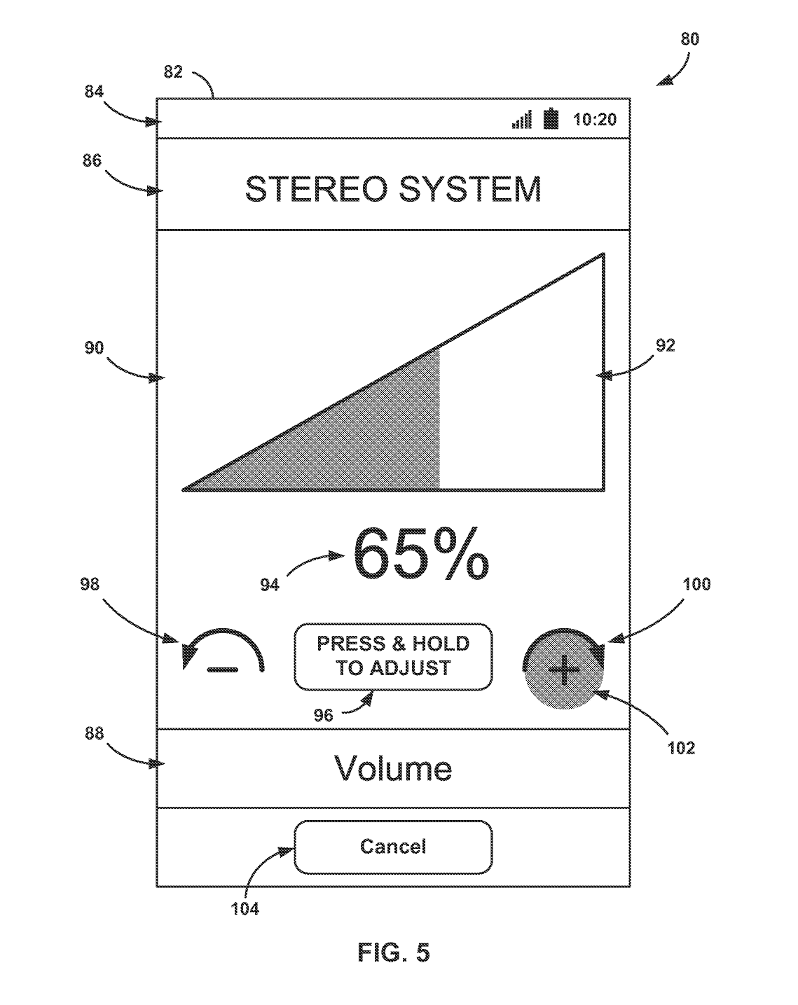

When computing device 12 receives the parameter information from remote server 18, computing device 12 may display or otherwise present the parameter information to the user. In one example, computing device 12 may use user interface 14 to present the parameter information to the user such as the parameter information illustrated in example FIG. 5. However, computing device 12 may additionally, or alternatively, use other output devices to present visual, audio, or even tactile feedback to the user according to the parameter information. In addition, computing device 12 may receive adjustments to the parameter value in response to remote server 18 adjusting the parameter value based on a function of the movement information transmitted by computing device 12. In this manner, the parameter value may be based on a function or relationship (e.g., a linear, logarithmic, discrete, polynomial, or other equation) between the parameter value and the movement information.

In addition to transmitting control information 26 to remote server 18, computing device 12 may also transmit movement information to remote server 18. Movement information may include any detection, sensed data, or measurements representative of the physical movement of computing device 12. In order to adjust the parameter identified by identification device 24, the user of computing device 12 may physically move computing device 12. The user may move computing device 12 whenever the user desires to change or adjust the parameter of control information 26. The physical movement of computing device 12 may be a tilt or rotation of computing device 12, a linear movement of computing device 12. Although the exact movement of computing device 12 may not be purely linear or purely rotational, computing device 12 may still detect the movement for the identified parameter.

Computing device 12 may sense or detect this physical movement using one or more sensors within computing device 12. These one or more sensors may include an accelerometer, gyroscope, compass, and camera. For example, a gyroscope may sense rotation of computing device 12 about an axis orthogonal to the plane of user interface 14 (e.g., an axis into user interface 14. In another example, an accelerometer may sense lateral or vertical motion of computing device 12. A visual indication on identification device 24 may notify the user of computing device 12 which movement can be used to control the parameter of target device 22. In other examples, computing device 12 may indicate how the user can move computing device 12 to adjust the parameter and operation of target device 22.

The magnitude of the sensed, or detected, movement of computing device 12 may determine the magnitude of the adjustment of the parameter of target device 22. The sensed movement may be the difference between two measured values from the output of the one or more sensors. In some examples, computing device 12 may determine the difference between the measured values to calculate the magnitude of the movement in a useable unit (e.g., degrees of rotation or centimeters of movement). This magnitude may then be sent as movement information to remote server 18. In other examples, computing device 12 may transmit two or more measured values from a sensor as the movement information. In other words, remote server 18 may perform any calculations and/or calibration of the measured values.

Once remote server 18 receives the movement information from computing device 12, remote server 18 may calculate the appropriate adjustment to the value of the parameter identified by control information 26. Remote server 18 may then transmit the adjusted value to target device 22 to affect the operation of target device 22. In addition, remote server 18 may transmit the adjusted value of the parameter to computing device 12 for presentation to the user via user interface 14. In alternative examples, computing device 12 may directly determine the adjusted value of the parameter based on instructions received from remote server 18 for determined the value of the parameter. Computing device 12 may thus determine the adjusted value of the parameter, present the adjusted value to the user via user interface 14, and transmit the adjusted value to remote server 18 such that remote server 18 may control target device 22 to adjust the value of the parameter. In some examples, computing device 12 may directly transmit the adjusted parameter value to target device 22.

In this manner, the user may adjust the parameter of target device 12 without providing input to computing device 12 via user interface 14. Instead, the user may hold computing device 12 in a hand and move computing device 12 in space to adjust the value of the parameter. This movement technique may facilitate control of target device 22 when using buttons, touch screens, or other input mechanisms may not be desired by the user. In addition, the movement technique may reduce the amount of time needed to adjust a parameter by reducing or eliminating the navigation of menus or other interfaces to control one or more different target devices. In other words, the user may adjust the intended parameter of target device 22 by placing computing device 12 in close proximity to identification device 24 and then moving computing device 12 in the appropriate fashion to adjust the parameter.

One or more identification devices 24 may be disposed at various locations around a room, a house, an office, a building, or any other space associated with target device 22. Multiple identification devices 24 may even be provided for the same parameter of the same target device 22. In this manner, the user may control that parameter at different locations (e.g., at any location of an identification device). In some examples, control information 26 from one identification device 24 may identify two or more parameters for target device 22. Different movements of computing device 12 may be used to adjust respective parameters. For example, computing device 12 may detect rotation of computing device 12 for adjusting a volume parameter and linear movement of computing device for changing between songs being played by target device 22. Identification device 24 may visual indicate which parameters are adjustable and what movements are required to adjust the respective parameters. Alternatively, user interface 14 may present the instructions for adjusting the parameters to the user. In most examples, control information 26 and the movement information transmitted to remote server 18 may allow target device 22 to be managed or otherwise controlled by a central server (e.g., remote server 18), a central database (e.g., remote database 20), or any web-based resource or service.

User interface 14 may include an input device and an output device so that the user can communicate with computing device 12. In one example user interface 14 may be a touch screen interface. In other examples, user interface 14 may include a display and one or more buttons, pads, joysticks, mice, or any other device capable of turning user actions into electrical signals that control computing device 12. In addition, computing device 12 may include one or more microphones, speakers, cameras, or tactile feedback devices to deliver information to the user or receive information. In any example, the user may interact with user interface 14 during the adjustment of the parameter when needed. For example, user interface 14 may present parameter information to the user.

The control of target device 22 may be managed by a service. This service may be internet based and accessed by the user using an application, web browser, or any other user interface that enables the user to interact with the service. In some cases the service may be accessed through a standalone application that is launched in response to obtaining control information 26 and operates with the operating system of computing device 12. Alternatively, the application may be a sub-routine built into an operating system running on computing device 12. In any case, computing device 12 may access the service to transmit control information 26 and movement information to the service (e.g., remote server 18). The service may directly control target device 22 transmitting parameter adjustments to target device 22 according to the movement of computing device 12. Although a standalone application may be used to access the services, the operating system may include the required functionality to directly interface with the control service (e.g., directly calling application programming interfaces (APIs) of the service with the operating system of computing device 12).

Computing device 12 may also include techniques to handle errors when obtaining control information 26, transmitting the obtained control information 26, and or receiving the parameter information from remote server 18. For example, computing device 12 may not recognize or be able to interpret control information 26 received from identification device 24. In this event, computing device 12 may prompt the user via user interface 14 to address this error in control information 26. For example, user interface 14 may prompt the user to reposition computing device 12 near identification device 24 or enable short-range communication of computing device 12 if the feature is not enabled.

Remote server 18 and remote database 20 may each include one or more servers or databases, respectively. In this manner, remote server 18 and remote database 20 may be embodied as any hardware necessary to receive control information 26, store the associations between control information 26 and the parameter of target device 22, or transmit parameter information to computing device 12 over network 16. Remote server 18 may include one or more desktop computers, mainframes, minicomputers, or other computing devices capable of executing computer instructions and storing data. Remote database 20 may include one or more memories, repositories, hard disks, or any other data storage device. In some examples, remote database 20 may be included within remote server 18.

Remote server 18 may connect to network 16. Network 16 may be embodied as one or more of the Internet, a wireless network, a wired network, a cellular network, or a fiber optic network. In other words, network 16 may be any data communication protocol that facilitates data between two or more devices.

In some examples, remote database 20 may include Relational Database Management System (RDBMS) software. In one example, remote database 20 may be a relational database and accessed using a Structured Query Language (SQL) interface that is well known in the art. Remote database 20 may alternatively be stored on a separate networked computing device and accessed by remote server 18 through a network interface or system bus. Remote database 20 may in other examples be an Object Database Management System (ODBMS), Online Analytical Processing (OLAP) database or other suitable data management system.

As described herein, computing device 12 may obtain control information 26 from identification device 24 that is associated with target device 22 (e.g., using a near-field communication module), wherein control information 26 identifies target device 22 and a parameter that at least partially defines operation of target device 22. Computing device 12 may also detect, with at least one sensor of computing device 12, physical movement of computing device 12 subsequent to obtaining control information 26. The physical movement of computing device 12 may result from a user moving computing device 12 with respect to identification device 24, the earth, the user, or any other reference point. Computing device 12 may also transmit control information 26 and movement information to a networked device (e.g., remote server 18) that is configured to adjust a value of the parameter of target device 22 based at least in part on the movement information of computing device 12. The movement information may include the detected physical movement (e.g., data representative of the detected movement) of computing device 12.

In another example, computing device 12 may include a computer-readable storage medium (e.g., a memory or removable media) encoded with instructions that cause one or more processors of computing device 12 to obtain control information 26 from identification device 24 that is associated with target device 22, wherein control information 26 identifies target device 22 and a parameter that at least partially defines operation of target device 22. The instructions may also cause the one or more processors to detect physical movement of computing device 12 (e.g., via one or more sensors under control of a processor) subsequent to obtaining control information 26 and transmit control information 26 and the movement information (e.g., via a telemetry module) to a networked device (e.g., remote server 18) configured to adjust a value of the parameter of target device 22 based at least in part on the movement information of computing device 12. As discussed above, the movement information may include the detected physical movement of computing device 12 in the form of data representative of the detected movement.

Computing device 12 may obtain control information 26 from identification device 24 via near-field communication as described herein. For example, computing device 12 may obtain control information 26 when computing device 12 is placed proximate to identification device 24. A user may hold computing device 12 in such a position. The proximity between computing device 12 and each identification device 24 may be a function of the signal producible by identification device 24. For identification devices (e.g. identification device 24) configured to be interrogated using NFC, computing device 12 may need to be placed within 10 centimeters of identification device 24. In other examples, computing device 12 may need to be placed within 4 centimeters, or even within approximately 2.5 centimeters of identification device 24 to obtain control information 26. The distance needed for communication may be dependent, at least in part, on the size and/or diameter of the antenna coil within computing device 12. Computing device 12 may obtain control information 26 at longer distances from identification device 24 with larger antennas. Although not necessary, computing device 12 may also touch, bump, or otherwise contact identification device 24 to obtain control information 26.

Alternatively, identification device 24 may have an image that is captured by computing device 12 to obtain control information 26. Computing device 12 may include a camera or other optical sensor capable of capturing image information. Identification device 24 may provide a visual code unique to identification device 24 and/or the parameter of target device 22. For example, this visual code may be a bar code, quick resource code (QR code), quick shot code, or any other unique visual pattern. In this manner, a computing device with only a camera may obtain control information 26. However, obtaining control information using short-range communication (e.g., NFC) may allow for obtaining control information 26 in low light conditions and/or without holding computing device 12 still with respect to identification device 24.

In some examples, identification device 24 may be a sticker, tag, coaster, relatively flat device, or any other package capable of performing the functions described herein. Identification device 14 may be configured to blend into the surface on which it is disposed or be otherwise visual innocuous. For example, identification device 24 may be painted the same color as the wall it is disposed. In other examples, identification device 24 may be associated with a visual representation of the parameter identified by control information 26. For example, identification device 24 may include a label or other print that indicates identification device 24 provides control information 26 associated with volume of a stereo system or light intensity of a light fixture. In this manner, the user of computing device 12 may obtain control information 26 from the desired identification device 24. In some examples, the visual representation may identify two or more identification devices

The movement information used by remote server 18 (or computing device 12 in some examples) to adjust the value of the identified parameter may be generated by computing device 12. One or more sensors housed by computing device 12 or otherwise coupled to computing device 12 may sense or detect physical movement of computing device 12 caused by the user. In this manner, the detected movement may be related to a magnitude change in the parameter of target device 12. In other words, larger movements of computing device 12 may correspond to a greater change in the value of the parameter. As described herein, the detected movement may be a change between two measured values from one or more sensors. Computing device 12 may generate the movement information with merely the measured values from the sensor or with a calculated absolute movement value. Remote server 18 may then translate the movement information into an adjustment to the parameter value of control information 26. Remote sever 18 may then transmit the adjusted parameter value to target device 22 to control the operation of target device 22 and, in some examples, transmit the adjusted parameter value to computing device 12 for presentation to the user as feedback for the physical movement.

Many different movements of computing device 12 may be detected and used to adjust the parameter value for controlling target device 22. For example, computing device 12 may detect rotation (or tilt), linear movement (e.g., translation), or any other combination of movements. In one example, computing device 12 may detect a tilt angle between a first measurement and a second measurement of the sensor. The tilt angle may be representative of a rotation about an axis orthogonal to the computing device. In other examples, the tilt angle may be a measure of the rotation of computing device 12 about an axis orthogonal to user interface 14. This tilt angle may simulate adjustment of an analog dial or similar input mechanism for controlling a device.

The first measurement for detecting the tilt angle may be taken upon obtaining control information 26 or otherwise receiving an input from the user indicating the adjustment is to begin. The second measurement may then be the latest, or most current, measurement from the sensor. The difference between the first and second measurements may thus be used to determine the tilt angle for adjusting the value of the parameter. In another example, the first and second measurements may represent the sensor output at consecutive sampling periods. In other words, computing device 12 may sample the output from the sensor at a predetermined frequency. The second measurement may be the most recent measurement and the first measurement may be the previous measurement. As the sensor output is sampled, the differences between consecutive first and second measurements may be summed during the adjustment period to provide an up-to-date adjustment to the parameter value. In this manner, computing device 12 may transmit subsequent measurements as each measurement is detected or at a separate transmission frequency. In one example, computing device 12 may transmit updated movement information whenever the difference between the first and second measurements is non-zero (e.g., the user has requested a change to the parameter value by moving computing device 12).

The sample rate of the output of the one or more sensors for detecting movement may generally be between approximately 1.0 Hz and approximately 1000 Hz. However, the sample rate may be lower or higher than that range in some examples. In other examples, the sample rate may be between approximately 5.0 Hz and 10 Hz. The sample rate may be selected based on hardware limitations and/or power use considerations. For example, the sample rate may be set to detect movement of computing device 12 without consuming more power than necessary. In other examples, the sample rate may be set based on the type of movement (e.g., rotation vs. linear movement) and/or user preferences.

Computing device 12 may detect the tilt angle (e.g., the rotation) from the user using a variety of sensors and methods. For example, computing device 12 may utilize one or more accelerometers that measure an orientation of computing device 23 with respect to gravity. The one or more accelerometers may be a one, two, or three axis accelerometer. Alternatively, computing device 12 may include two or more different accelerometers for measuring the relative rotation of computing device 12. The tilt angle may be determined by measuring the angle between two vectors in time. The angle may be the absolute angle between the vectors. However, the tilt angle may alternatively be the angle using only two axes in the plane of user interface 14. In other examples, an angle between two vectors in three-dimensions may be only determined within a specific place (e.g., the plane of user interface 14 or computing device 12). In this manner, computing device 12 may determine the tilt angle without distortion from undesired tilt outside of the plane desired for adjusting the parameter. In some examples, computing device 12 may use an accelerometer to detect the tilt angle whenever computing device 12 oriented vertical with respect to the ground.

In another example, computing device 12 may detect the tilt angle by measuring an orientation of computing device 12 with respect to earth's magnetic field. Computing device 12 may include a sensor in the form of a compass configured to detect the surrounding magnetic field. For the compass to function as sensor to detect the tilt angle, the user may orient computing device 12 in a position approximately parallel to the ground (i.e., the earth). Rotation of computing device 12 may then occur generally in the plane parallel to the ground. In some examples, computing device 12 may use the compass to detect the tilt angle whenever computing device 12 oriented parallel to the ground.

In other examples, computing device 12 may detect the tilt angle by measuring an angular acceleration of computing device 12. Computing device 12 may include one or more gyroscopes or other sensors configured to detect the angular acceleration of computing device 12. The detected angular acceleration of computing device 12 may be used to identify the direction and magnitude of the rotation of computing device 12. For example, double integrating the angular acceleration may result in the angular distance, e.g., the tilt angle, computing device 12 moved between subsequent measurements. Single integration of the angular acceleration may yield an angular velocity that may be used to vary the rate at which the parameter is adjusted. In other words, higher angular velocities may indicate that the user desires to make a larger magnitude change in the parameter value. Remote sever 18 may thus increase the parameter value change per unit of angular distance. Conversely, lower angular velocities may indicate that the user desires to make more fine adjustments to the parameter. Remote sever 18 may thus decrease the parameter value change per unit of angular distance. In this manner, computing device 12 and/or remote server 18 may provide an adaptive adjustment rate reflective of the detected rotational rate of computing device 12. This adaptive adjustment rate may be applicable to any technique for detecting movement of computing device 12 (e.g., rotational or linear movement).

In other examples, computing device 12 may detect linear movement of computing device 12 to adjust the value of the parameter. For example, computing device 23 may include an accelerometer or other sensor that measures one or more accelerations of computing device 12. Computing device 12 and/or remote server 18 may then calculate a distance and direction computing device 12 was moved between a first measurement and a second measurement. For example, computing device 12 may take the double integral of the acceleration measured over a selected time period to calculate the distance computing device 12 was moved through space. In some examples, computing device 12 may correct the calculated distance to account for movement out of the plane of user interface 14 if computing device 12 is to move only left, right, up, or down.

In this manner, the detected movement may be movement detected from an accelerometer or other linear movement sensors. The accelerometer may include one or more three-axis accelerometers. In one example, computing device 12 may measure accelerations of computing device 12 after obtaining control information 26 and calculate the distance and direction computing device 12 was moved between subsequent measurements after obtaining control information 26. The distance computing device 12 has been moved may be calculated by double integration of the accelerometer measurements. In addition, the direction may be determined integrating the acceleration measurements from the previous identification device 24 and determining a speed vector in two or three dimensions.

In some alternative examples, computing device 12 may detect movement of computing device 12 by capturing a plurality of images with a sensor of the computing device. The sensor may be an image sensor disposed on a surface of computing device 12 that faces identification device 24 and the surface on which identification device 24 is located (e.g., a rear facing camera). From the captured images, computing device 12 may calculate a distance and a direction that computing device 12 was moved from the detected identification device 24 based on a rate and direction one or more pixels have moved between the captured images. Computing device 12 may, in one example, analyze the captured images, identify common features between the images (e.g., common groups of pixels), count the number of pixel changes between each image, and estimate the movement of computing device 12 based on the number of counted pixels. Computing device 12 may also employ other algorithms selected to convert feature movement between images to distance moved. These algorithms may incorporate additional data, such as focal length, to calibrate the distance per pixel calculation. In other words, larger focal lengths in the images may indicate a larger coverage length of the image for each pixel.

In addition computing device 12 may calculate a direction that computing device 12 has moved based on how many pixels the structures in the images moved in two dimensions. This vector may indicate an angle with respect to identification device 24. Over multiple images, computing device 12 may add the vectors of each change in the images to determine a resulting movement of computing device 12. This resulting movement, both direction and distance, may be transmitted by computing device 12 to remote sever 18 via network 16 such that remote server 18 can determine the movement of computing device 12 and the adjustment to the value of the identified parameter of control information 26.

Since the target device 22 may be controlled by remote server 18 based on the physical movement of computing device 12, computing device 12 may not be able to interpret control information 26 to identify what adjustment will be made to the parameter of target device 22. Therefore, computing device 12 may receive the adjusted value of the parameter from remote server 18 after the adjustment is made. In other words, remote server 18 may transmit the adjusted value to computing device 12 via network 16 after the adjustment has been made or upon determining the adjusted value of the control parameter. Computing device 12 may also present the adjusted value of the control parameter using user interface 14. Therefore, the user of computing device 12 may receive feedback as to how the control parameter has changed based on the movement of computing device 12.

In some examples, any physical movement of computing device 12 detected after obtaining control information 26 may be used to adjust the value of the identified parameter. Computing device 12 may stop transmitting movement information to remote server 18 (e.g., terminate the adjustment of the parameter) upon losing communication with identification device 24 (e.g., no longer able to obtain control information 26 from identification device 24. In other examples, computing device 12 may stop transmitting movement information to remote server 18 in response to receiving a cancel input from the user via user interface 14. In this manner, the user may take computing device 12 anywhere to adjust the parameter value after obtaining control information 26. In other examples, computing device 12 may cancel adjustment after a predetermined elapsed time and/or an elapsed time from the last detected movement of computing device 12.

Alternatively, the movement information transmitted by computing device 12 to remote server 18 for adjusting the value of the parameter may only include detected movement selected by the user. For example, computing device 12 may receive a clutch input during the detection of movements. The clutch input may include depressing a button or touching a defined region of user interface 14. For example, the button for the clutch may be a side switch on the side of computing device 12 for manipulation when computing device 12 is gripped by a hand of the user. In another example, the button may be a pressure sensor disposed along a side of the housing of computing device 12. The pressure sensor may detect when the user squeezes computing device 12 beyond a threshold that is representative of the clutch input. Initiation of the clutch input may define the first measurement and termination of the clutch input may define the second measurement of the sensor. In other words, only movements detected when the clutch input is selected may be used to adjust the parameter value. The clutch input may allow the user more control over how to adjust the parameter value.

The clutch input may allow the user to move computing device 12 back and forth while adding only those movements in a certain direction. In other words, computing device 12 may be subject to multiple passes through a movement range to further increase, or further decrease, the value of the parameter. For example, the user may provide the clutch input during a clockwise rotation of computing device 12, terminate the clutch input and rotate computing device 12 counter-clockwise, then provide the clutch input a second time during a subsequent clockwise rotation. In this example, the parameter value would only be adjusted during the clockwise rotations (e.g., adding the second clockwise rotation to the value without subtracting the intermediary counter-clockwise rotation). The clutch input may need to be continually provided to adjust the parameter value with the movement during the clutch input. Alternatively, the clutch input may be provided once to start the adjustment and provided a second time to terminate the adjustment.

Control information 26 obtained by computing device 12 may include a uniform resource locator (URL) configured to direct a browser of computing device 12 to web-based service associated with the networked device (e.g., remote server 18). The URL may include a code that identifies the parameter and target device 22. Alternatively, control information 26 may include a unique code such as a numerical identifier, alpha-numeric identifier, hexa-decimal number, or any other identifier. This unique code of control information 26 may also be stored in remote database 20 and linked to the appropriate target device 22 and parameter. In this manner, identification device 24 may be re-linked to a different parameter and/or target device via remote server 18 and without re-writing or re-configuring identification device 24. In other examples, control information 26 may include data that computing device 12 can interpret and use to identify target device 22 and/or the parameter to be adjusted.

In some examples, control information 26 may include a command that instructs computing device 12 to perform an action (e.g., transmit control information 26 to an identified remote server 18). In other examples, computing device 12 may perform the action based on the type of data contained in control information 26. In either example, computing device 12 may launch a control application on computing device 12 in response to obtaining control information 26. The control application may at least partially control detecting movement of computing device 12 (e.g., how to utilize the one or more sensors and/or data from the one or more sensors) and transmit control information 26 to remote server 18. In addition, computing device 12 may terminate the control application in response to receiving at least one of a termination input or a loss of communication with identification device 24.

Since remote server 18 may determine what adjustment to make to the parameter based on the movement information transmitted by computing device 12, computing device 12 may not determine how the parameter is adjusted from the detected movement. Therefore, computing device 12 may receive an adjusted value of the parameter based on the control information and/or the movement information. Remote server 18 may transmit parameter information to computing device 12 in response to receiving control information 26 and/or in response to adjusting the parameter value based on the detected movement. Computing device 12 may then utilize user interface 14 (e.g., including a display) to present the adjusted value of the parameter to the user. The adjusted value of the parameter may be a form of feedback to the user as to what subsequent movements are needed to further adjust or stop adjusting the parameter value.

In other examples, computing device 12 may deliver an audio feedback to a user based on a magnitude of the detected physical movement. For example, computing device 12 may provide one or more “beeps” or other sounds to the user in response to detecting the movement and/or the adjusted value of the parameter from remote server 18. In addition, computing device 12 may provide tactile feedback (e.g., vibrations) to the user to indicate detected movements, magnitude of the movement, and/or adjustments to the parameter.

As discussed herein, computing device 12, identification device 24, and target device 22 may be different devices. In combination, these different devices may be used to adjust one or more parameters of target device 22. System 10, and similar systems utilizing identification device 24, may be utilized to adjust such a parameter that defines operation of target device 22 (e.g., a sound system, a video system, a lighting system, a heating system, etc.). In other words, a user may adjust, modify, or change a control parameter of a target device by obtaining control information 26 from one or more identification device 24, detecting movement of computing device 12, and transmitting control information 26 and the detected movement to remote server 18. Computing device 12 may obtain information from identification device 24 using near-field communication. The information may identify a parameter and that at least partially defines operation of target device 22.

Control information 26 may identify a parameter that at least partially defines operation of target device 22. As indicated above, target device 22 may be any device capable of electronic control. For example, target device 22 may be used to provide entertainment, climate control, lighting, or any other service to the user. Target device 22 may be a component of an audio system, a video component of a video system, a lighting control device, a thermostat that controls a heating and cooling system, a security system, or even another computing system. In this manner, the control parameter may be a volume control, a channel control, an input control, a light intensity control, a temperature control, a video camera directional control, a motor control, a fan control, a timer (e.g., an on-timer or an off-timer), a toggle control (e.g., a garage door opener), a delay timer (e.g., a dishwasher delay), a rotational control (e.g., an antenna rotator), or any other such parameter that at least partially defines the operation of target device 22. The control parameter may thus be adjusted to a variety of values as desired by the user based on the detected movement of computing device 12.

Various aspects of the disclosure may be operable only when the user has explicitly enabled such functionality. In addition, various aspects of the disclosure may be disabled by the user. Thus, a user may elect to prevent computing device 12 from transmitting control information 26 and/or movement information to remote server 18 or receive parameter information directly from remote server 18. More generally, privacy controls may be applied to all aspects of the disclosure based on a user's privacy preferences to honor the user's privacy preferences for opting in or opting out of the functionality described in this disclosure.

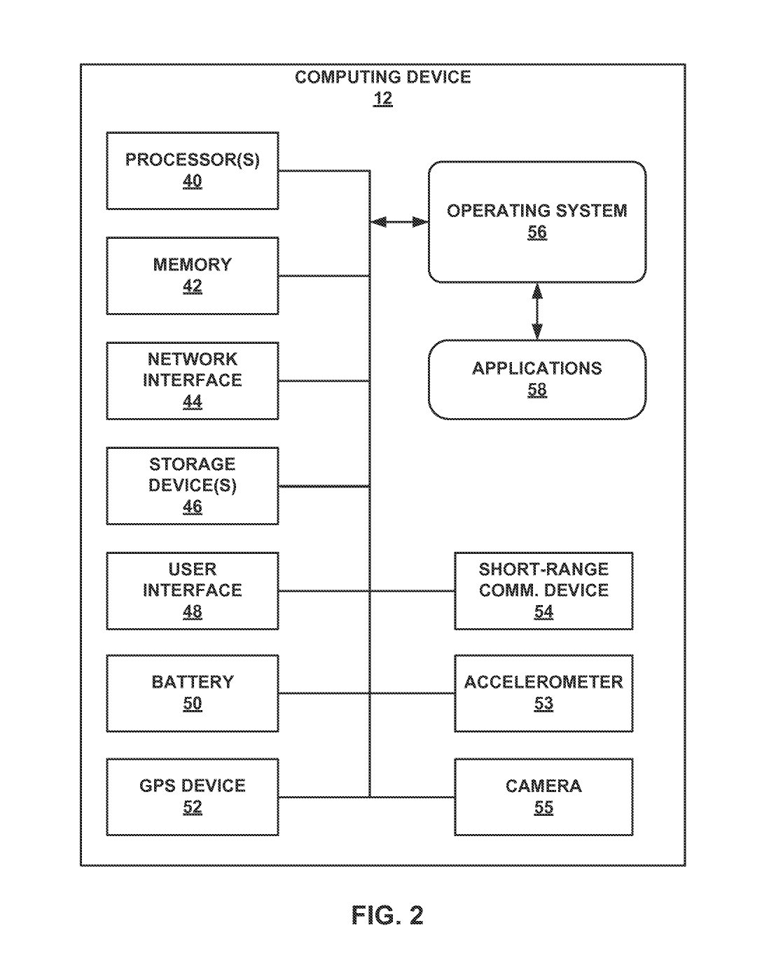

FIG. 2 is a block diagram illustrating components of one example of computing device 12 shown in FIG. 1. FIG. 2 illustrates only one particular example of computing device 12, and many other example embodiments of computing device 12 may be used in other instances. For example, computing device 12 may include additional components and run multiple different applications.

As shown in the specific example of FIG. 2, computing device 12 includes one or more processors 40, memory 42, a network interface 44, one or more storage devices 46, user interface 48, battery 50, GPS device 52, short-range communication device 54, accelerometer 53, and camera 55. Computing device 12 also includes an operating system 56, which may include modules and/or applications that are executable by processors 40 and computing device 12. Computing device 12, in one example, further includes one or more applications 58. One or more applications 58 are also executable by computing device 12. Each of components 40, 42, 44, 46, 48, 50, 52, 53, 54, 55, 56, and 58 may be interconnected (physically, communicatively, and/or operatively) for inter-component communications.

Processors 40, in one example, are configured to implement functionality and/or process instructions for execution within computing device 12. For example, processors 40 may be capable of processing instructions stored in memory 42 or instructions stored on storage devices 46. These instructions may define or otherwise control the operation of operating system 56 and applications 58.

Memory 42, in one example, is configured to store information within computing device 12 during operation. Memory 42, in some examples, is described as a computer-readable storage medium. In some examples, memory 42 is a temporary memory, meaning that a primary purpose of memory 42 is not long-term storage. Memory 42, in some examples, is described as a volatile memory, meaning that memory 42 does not maintain stored contents when the computer is turned off. Examples of volatile memories include random access memories (RAM), dynamic random access memories (DRAM), static random access memories (SRAM), and other forms of volatile memories known in the art. In some examples, memory 42 is used to store program instructions for execution by processors 40. Memory 42, in one example, is used by software or applications running on computing device 12 (e.g., one or more of applications 58) to temporarily store information during program execution.

Storage devices 46, in some examples, also include one or more computer-readable storage media. Storage devices 46 may be configured to store larger amounts of information than memory 42. Storage devices 46 may further be configured for long-term storage of information. In some examples, storage devices 46 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 12, in some examples, also includes a network interface 44. Computing device 12, in one example, utilizes network interface 44 to communicate with external devices via one or more networks, such as network 16 in FIG. 1. Network interface 44 may be a network interface card, such as an Ethernet card, an optical transceiver, a radio frequency transceiver, or any other type of device that can send and receive information. Other examples of such network interfaces may include Bluetooth, 3G and WiFi radios in mobile computing devices as well as USB. In some examples, computing device 12 utilizes network interface 44 to wirelessly communicate with an external device (not shown) such as a server, mobile phone, or other networked computing device.

Computing device 12, in one example, also includes one or more user interfaces 48. User interface 48 may be an example of user interface 14 described in FIG. 1. User interface 48 may be configured to receive input from a user (e.g., tactile, audio, or video feedback). User interface 48 may include a touch-sensitive and/or a presence-sensitive screen, mouse, a keyboard, a voice responsive system, or any other type of device for detecting a command from a user. In some examples, user interface 48 includes a touch-sensitive screen, mouse, keyboard, microphone, or camera.

User interface 48 may also include, combined or separate from input devices, output devices. In this manner, user interface 48 may be configured to provide output to a user using tactile, audio, or video stimuli. In one example, user interface 48 may include a touch-sensitive screen, sound card, a video graphics adapter card, or any other type of device for converting a signal into an appropriate form understandable to humans or machines. In addition, user interface 48 may include a speaker, a cathode ray tube (CRT) monitor, a liquid crystal display (LCD), or any other type of device that can generate intelligible output to a user.

Computing device 12, in some examples, include one or more batteries 50, which may be rechargeable and provide power to computing device 12. Battery 50, in some examples, is made from nickel-cadmium, lithium-ion, or other suitable material. In other examples, battery 50 may be a power source capable of providing stored power or voltage from another power source.

Computing device 12 may also include one of more GPS devices 52. GPS device 52 may include one or more satellite radios capable of determining the geographical location of computing device 12. Computing device 12 may utilize GPS device 52 to confirm the validity of visual media 22, for example. Alternatively, computing device 12 may transmit the GPS coordinates to remote server 18 to identify the location and the specific visual media 22.

In addition, computing device 12 may include one or more short-range communication device 54. For example, short-range communication device 54 may be an NFC device. As described herein, short-range communication device 54 may be active hardware that is configured to obtain location information from identification device 24. In general, short-range communication device 54 may be configured to communicate wirelessly with other devices in physical proximity to short-range communication device 54 (e.g., approximately 0-100 meters). In other examples, short-range communication device 54 may be replaced with an alternative short-range communication device configured to obtain control information 26 from respective identification device 24. These alternative short-range communication devices may operate according to Bluetooth, Ultra-Wideband radio, or other similar protocols.

Computing device 12 may also include various sensors. Computing device 12 may include one or more accelerometers 53 that sense accelerations of computing device 12. Accelerometer 53 may be a three-axis accelerometer that senses accelerations in multiple dimensions. Alternatively, accelerometer 53 may include two or more single-axis or two-axis accelerometers. Computing device 12 may utilize accelerometer 53 to detect physical movement of computing device 12 for adjusting the parameter identified by control information 26. In other examples, computing device 12 may also include one or more gyroscopes to sense angular acceleration or compasses to sense the direction computing device 12 with respect to the earth's magnetic field.

Camera 55 may be an optical sensor that computing device 12 controls. Computing device 12 may capture images and/or video using camera 55. In some examples, camera 55 may be used to detect movement of computing device 12 with respect to identification device 24 and/or another surface. Camera 55 may be located on any surface of computing device 12 in some examples. In other examples, computing device 12 may include two or more cameras.

Computing device 12 may include operating system 56. Operating system 56, in some examples, controls the operation of components of computing device 12. For example, operating system 56, in one example, facilitates the interaction of application 58 with processors 40, memory 42, network interface 44, storage device 46, user interface 48, battery 50, GPS device 52, short-range communication device 54, accelerometer 53, and camera 55.

Application 58 may be an application configured to manage obtaining control information 26, transmitting control information 26 to remote server 18, detecting movement of computing device 12, receiving parameter information from remote server 18, and presenting the parameter information on computing device 12. Application 58 may control one or more of these features. Application 58 may thus control any aspect of interaction with identification device 24 and remote server 18. Application 58 may be automatically launched upon obtaining control information 26 if application 58 is not already being executed by processors 40. Application 58 may also be used to measure and/or calculate the detected movement of computing device 12 or any other functionality described herein. Although one application 58 may manage obtaining control information 26 and adjusting the control parameter with the detected movement, separate applications may perform these functions in other examples. Although application 58 may be software independent from operating system 56, application 58 may be a sub-routine of operating system 56 in other examples.

Computing device 12 may utilize additional applications to manage any functionality described herein with respect to system 10 or other aspects of computing device 12. Any applications (e.g., application 58) implemented within or executed by computing device 12 may be implemented or contained within, operable by, executed by, and/or be operatively/communicatively coupled to components of computing device 12 (e.g., processors 40, memory 42, network interface 44, and/or storage devices 46).

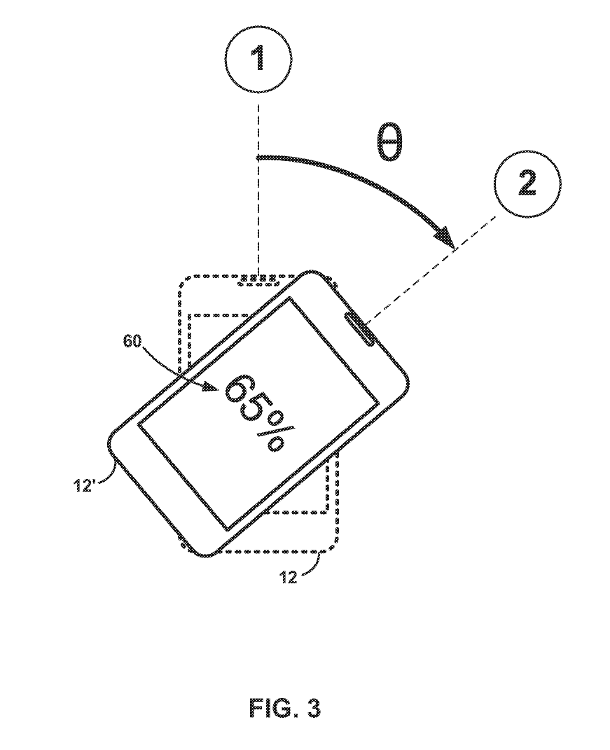

FIG. 3 is a conceptual diagram illustrating rotational movement of computing device 12 to adjust a parameter of target device 22. As described herein, many different movements of computing device 12 may be detected and used to adjust the parameter value for controlling target device 22. As shown in the example of FIG. 3, a sensor may detect rotation (or tilt) of computing device 12. Computing device 12 may detect a tilt angle θ between a first measurement (e.g., at position 1) and a second measurement (e.g., at position 2) from the sensor. In other words, computing device 12 is oriented at position 1 and computing device 12′ is oriented at position 2. The tilt angle θ may be a measure of the rotation of computing device 12 about an axis orthogonal to user interface 14 (e.g., into the page of FIG. 3). This tilt angle θ may simulate adjustment of an analog dial or similar input mechanism for controlling a device.

The first measurement at position 1 may be taken upon obtaining control information 26 or otherwise receiving an input from the user indicating the adjustment is to begin. The first measurement may thus be the starting angle or reference angle for measuring the movement of computing device 12. The second measurement at position 2 may then be the latest, or most current, measurement from the sensor. The difference between the first and second measurements may thus be used to determine the tilt angle θ for adjusting the value of the parameter. Parameter value 60 is shown as presented by user interface 14. In the example of FIG. 3, parameter value 60 may have changed from 50% (not shown) at position 2 to 65% at position 2 (shown). Tilt angle θ may thus correspond to a 15% increase in the value of parameter 60 (e.g., volume).

Tilt angle θ may be the angle between the beginning and end of the adjustment to parameter 60. Alternatively, two or more tilt angles may be calculated in the interim as computing device 12 is rotated between position 1 and position 2. In any case, computing device 12 may detect movement of computing device 12 as computing device is rotated and transmit the detected movement to remote server 18. Rotation in one direction (e.g., clockwise) may increase the value of the parameter while rotation in another direction (e.g., counter-clockwise) may decrease the value of the parameter. The specific direction of movement required to increase or decrease the parameter may be selected by the user or preset by control information 26 and/or parameter information received from remote sever 18. Computing device 12 may continue to be rotated clockwise or counter-clockwise. However, computing device 12 may receive a clutch input from the user to allow adjustment of the parameter using only a limited rotational angle (e.g., angles limited by rotating a human wrist).

The magnitude of the adjustment may be mapped to the magnitude of the detected tilt angle θ. For example, one degree of tilt angle θ may correspond to a one percent adjustment in the value of the parameter. However, this sensitivity may be adjusted such that one degree of tilt angle θ corresponds to less than one percent of an adjustment or more than one percent of adjustment. The tilt angle θ may also correspond to absolute values of the parameter, e.g., decibels of a volume or a television channel) in other examples.

The available rotation, or maximum tilt angle θ, to adjust the parameter may be referred to as an adjustment range. The adjustment range may be set to a predetermined degree of rotation based on how much the user can rotate computing device 12 and/or a sensitivity for adjusting the parameter. In one example, the adjustment range may cover a 180-degree rotation. When computing device 12 is vertical, the value of the parameter is set to the current value when control information 26 was received. Rotating computing device 12 90 degrees clockwise may increase the parameter to the maximum value of the range while rotating computing device 12 90 degrees counter-clockwise may decrease the parameter to the minimum value of the range. The adjustment range may alternatively be set to 90 degrees, 120 degrees, 360 degrees, or even greater than 360 degrees of rotation. When the adjustment range is used to limit the amount of rotation needed, remote server 18 may scale tilt angle θ to the remaining possible adjustment of the parameter value. In other examples, the adjustment range for the tilt angle may be set based on the value of the parameter and the available adjustment of the value.

The sensitivity of the change to the parameter value for the detected movement may be stored by remote database 20. In addition, the range of the available tilt angle may be stored by remote database 20. In other examples, the sensitivity and/or range of the parameter may be stored by computing device 12. In addition, the rate of parameter value change may be adaptive based on the speed of rotation in other examples.

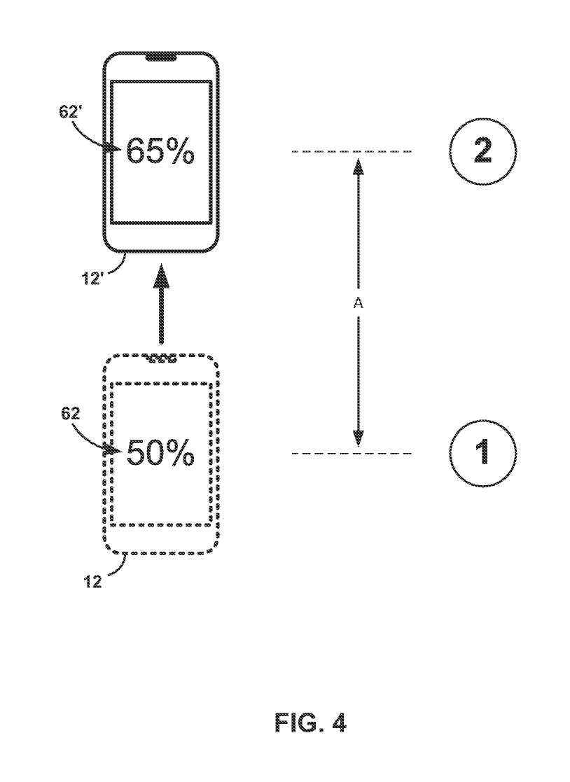

FIG. 4 is a conceptual diagram illustrating linear movement of computing device 12 to adjust parameter 62 of target device 22. As described herein, many different movements of computing device 12 may be detected and used to adjust the parameter value for controlling target device 22. As shown in the example of FIG. 4, a sensor may detect linear movement of computing device 12. Computing device 12 may thus be capable of determining, or estimating, the distance A between location 1 and location 2. Distance A may be determined at any point in time and may be updated as computing device 12 is moved with respect to location 1. By determining distance A from identification device 24, computing device 12 and/or remote device 18 may be able to identify the movement of computing device 12 and the appropriate adjustment to the identified parameter value.

Location 1 may be the location of identification device 24. Although distance A between locations 1 and 2 of FIG. 4 may be a vertical distance, distance A may be in any direction from identification device 24. For example, computing device 12 may be moved in a diagonal direction or horizontal direction with respect to identification device 24 and distance A may still be measured in accordance to the direction in which computing device 12 has moved. However, opposing directions may be used to adjust the parameter value in opposite directions. For example, moving computing device 12 up may increase the value of the parameter and moving computing device 12 down may decrease the value of the parameter. Therefore, the movement detected by computing device 12 may have a direction component and a magnitude component. This directional component may also be able to use linear movement to adjust two or more parameters (e.g., vertical movement for one parameter and horizontal movement for a second parameter).

Computing device 12 may begin sensing and determining movement in response to obtaining control information 26 from identification device 24. In another example, computing device 12 may continuously sense and determine movement before and after obtaining control information 24. However, computing device 12 may only utilize the movement detected after obtaining the control information to update the movement of computing device 12. In other examples, computing device 12 may begin sensing and determining movement of computing device 12 when the clutch input is received. In another example, computing device 12 may change the detection rate (e.g., the rate of the sensor that senses the movement) in response to obtaining control information or after a predetermined period of time after obtaining the control information. For example, computing device 12 may increase the detection rate from a low detection to a high detection rate to provide a more accurate estimation of the physical movement of computing device 12.

As described herein, computing device 12 may use a sensor within computing device 12 to detect movement of computing device 12. Computing device 12 may then transmit the detected movement to a networked device (e.g., remote server 18). In one example, computing device 12 may include one or more accelerometers (e.g., accelerometer 53 of FIG. 2) that detect movement of computing device 12 by measuring accelerations of computing device 12 after obtaining control information 26 from identification device 24. After the accelerations are measured, computing device 12 may calculate a distance and a direction that computing device 12 was moved based on the measured accelerations. The accelerations may be measured with a two or three axis accelerometer or multiple accelerometers arranged orthogonally to each other. This acceleration measurement method may be referred to as an inertial measurement to interpolate the distance between two positions (e.g., position 1 and position 2).

The measured accelerations (e.g., sensor values obtained from the accelerometer sensor) may be used to measure the moved distance by double integrating the measured accelerations, for example. In the example of FIG. 4, the first measurement may be made at position 1 and the second measurement may be made at position 2. The distance may be calculated periodically and added to previously measured distances or calculated at a single time determined based on stopped movement or some other detected indication that the distance should be calculated. For example, the new position of computing device 12 may be determined in two dimensions in a plane parallel with user interface 14 of computing device 12. The following equation may be used to determine the new position of computing device 12:

Distance(X,Y)=Distance(Integral(Integral(AccX,t),t),Integral(Integral(AccY,t),t)). (1)

Equation 1 illustrates the example method for determining the distance computing device 12 has moved by double integration of each X and Y directional component of the sensor output. X is the distance moved in the X direction and Y is the distance moved in the Y direction. AccX is the acceleration value in the X direction over time t and AccY is the acceleration value in the Y direction over time t. Distance A may correspond to Y in this example of FIG. 4. When each acceleration value is integrated twice and added to the previous, or old, position, the detected movement has been used to calculate or estimate the location of computing device 12. Either the X distance or Y distance, or both, may be used to calculate the appropriate adjustment to the identified parameter (e.g., parameter 62).

For example, computing device 12 at position 1 has a value of 50% for parameter 62. After computing device 12 has been moved vertically upward (e.g., computing device 12′ at position 2), the value of parameter 62′ has been adjusted to 65%. In other words, detected movement of distance A may correspond to a parameter change of approximately 15%. Moving computing device 12 further upward may further increase the parameter value. Conversely, moving computing device 12 downward may decrease the parameter value.

In some examples, computing device 12 may directly calculate movement of computing device 12 based on the acceleration measurements and transmit the calculated movement as movement information. Remote server 18 may then use the movement information to make the corresponding adjustment to the identified parameter from control information 26. In this manner, computing device 12 and remote server 18 may each contribute to calculating the movement of computing device 12. Alternatively, remote sever 18 may perform most of the calculations to determine movement of computing device 12. Computing device 12 may simply transmit sensed or measured values from the one or more accelerometers, and calibration information if necessary, to remote server 18. Remote server 18 may then calculate the distance and direction computing device 12 has moved and the adjusted value of the parameter. In any case, remote server 18 may use the newly calculated movement of computing device 12 to adjust the parameter value and transmit the adjusted value of the parameter to target device 22 and computing device 12 as parameter information.

The magnitude of the adjustment may be mapped to the magnitude of distance A. For example, one centimeter of movement may correspond to a five percent adjustment in the value of the parameter. However, this sensitivity may be adjusted such that one centimeter of linear movement corresponds to less than five percent of an adjustment or more than five percent of adjustment. The distance A may also correspond to absolute values of the parameter, e.g., decibels of a volume or a television channel) in other examples. In addition, the rate of parameter value change may be adaptive based on the speed of rotation in other examples.

The available movement, or maximum distance A, to adjust the parameter may be referred to as an adjustment range. The adjustment range may be set to a predetermined distance based on how a reasonable distance to move computing device 12 and/or a sensitivity for adjusting the parameter. Generally, the adjustment range may be between approximately 2.0 centimeters and 100 centimeters. However, the adjustment range may be less than 2.0 centimeters or greater than 100 centimeters in other examples. In one example, the adjustment range may be approximately 40 centimeters. Moving computing device 12 up 20 centimeters may increase the parameter value to the maximum value of the parameter and moving computing device 20 centimeters down may decrease the parameter value to the minimum value of the parameter. When the adjustment range is used to limit the amount of movement needed, remote server 18 may scale distance A to the remaining possible adjustment of the parameter value. In other examples, the adjustment range for the linear movement may be set based on the value of the parameter and the available adjustment of the value.

The sensitivity of the change to the parameter value for the detected movement may be stored by remote database 20. In addition, the range of the available movement distance may be stored by remote database 20. In other examples, the sensitivity and/or range of the parameter may be stored by computing device 12. In addition, the rate of parameter value change may be adaptive based on the speed of movement in other examples.

FIG. 5 is an illustration of an example user interface 80 containing parameter information 90 received based on control information 26 obtained from identification device 24 and physical movement of computing device 12. Since target device 22 may be controlled by remote server 18 based on the physical movement of computing device 12, computing device 12 may not be able to interpret the detected movement to directly identify what adjustment will be made to the control parameter. Therefore, computing device 12 may receive the adjusted value of the control parameter from remote server 18 via network 16. In other words, remote server 18 may transmit the adjusted value to computing device 12 via network 16 after the adjustment has been made or upon determining the adjusted value of the control parameter. Computing device 12 may then present the adjusted value of the control parameter using user interface 14. Therefore, the user of computing device 12 may receive feedback as to how the control parameter has changed based on the movement of computing device 12.

User interface 80 is an example of user interface 14. As shown in FIG. 5, user interface 80 presents screen 82 to the user via computing device 12. Screen 82 includes status bar 84, target device field 86, value information 90, clutch input 96, decrease indicator 98, increase indicator 100, adjustment indicator 102, control parameter field 88, and cancel input 104. Screen 82 may be an example screen within application 58 of FIG. 2 (e.g., an application for providing parameter information associated with adjusting the parameter) running on computing device 12. For example, the parameter information of screen 82 may be at least partially received from remote server 18 and include details about the adjusted parameter and target device 22.

Status bar 84 may include one or more icons that indicate the status of computing device 12 and/or applications running on computing device 12. For example, status bar 84 may present a time of day, battery charge level, network signal strength, application updates, received messages, or even notification that control information 26 has been received from identification device 24. Target device field 86 may indicate the target device that is being at least partially controlled based on the adjusted parameter. Target device field 86 indicates that “Stereo System” is the target device being controlled. Control parameter field 88 may indicate the parameter that was just adjusted based on the position information and detected movement of computing device 12. Control parameter field 88 indicates that the control parameter of “Volume” has been adjusted.

Value information 90 may provide any information related to the adjustment of the identified parameter. Value information 90 may include any graphical, numerical, or textual information that indicates the present value of the control parameter and/or how the value has been adjusted. In the example of FIG. 5, value information 90 includes value 94 and graph 92. Value 94 indicates the numerical value of the control parameter as it has been adjusted. Value 94 may be presented as a percentage of the total possible value of the control parameter (e.g., 65 percent of the total available volume) or as an absolute value of the control parameter (e.g., 85 decibels for volume). If computing device 12 is subsequently moved to adjust the value of the parameter, computing device 12 may update value information 90 according to the received adjustment (e.g., the parameter information) from remote server 18. Graph 92 provides a graphical indication of the currently adjusted control parameter. The shaded portion of graph 92 indicates the used volume level. In other words, the value of the control parameter would be set to maximum if the entire graph 92 was shaded.

Value 94 and graph 92 are examples of possible indications of the adjusted value of the control parameter. Value information 90 may include, in other examples, dials, bar graphs, text, or any other manner of displaying the value of the control parameter. In addition, value information 90 may provide values to different control parameters for the target device. Screen 82 may be presented automatically on computing device 12 in response to receiving the adjusted value of the control parameter from remote server 18. Alternatively, computing device 12 may prompt the user to view the control parameter or the user may navigate one or more menus of computing device 12 to initiate display of screen 82.

In addition to the value of the parameter, screen 82 may provide additional information and control for adjusting the parameter. In some examples, identification device 24 may not include information about how the user can move computing device 12 to adjust the parameter value. Therefore, screen 82 may include decrease indicator 98, increase indicator 100, and adjustment indicator 102. Decrease indicator 98 and increase indicator 100 may instruct the user what movements of computing device 12 will adjust the parameter value. Screen 82 may illustrate rotational movement. Decrease indicator 98 indicates that rotation of computing device 12 counter-clockwise may decrease (e.g., the minus sign) the value of the parameter. Conversely, Increase indicator 100 indicates that rotation of computing device 12 clockwise may increase (e.g., the plus sign) the value of the parameter. Adjustment indicator 102 may highlight the appropriate indicator 98 or 100 based on the latest, or current, movement of computing device 12. In the example of FIG. 5, adjustment indicator 102 indicates that the value of the parameter has most recently increased by highlighting increase indicator 100. Instead of adjustment indicator 102, user interface 80 may alternatively flash, blink, change the color or otherwise indicate how the user is adjusting the parameter value. In other examples, screen 82 may not provide one or more of these indicators.

Clutch input 96 may also be provided, in some examples, so the user can select which movement is used to adjust the parameter value. For example, computing device 12 may only transmit detected movements to remote server 18 when the user presses and holds clutch input 96. Alternatively, the user may press clutch input 96 to start adjusting the parameter value and press clutch input 96 again to stop adjusting the parameter value. Clutch input 96 may alternatively be provided by allowing touch input anywhere within screen 82, a physical button, or other input methods. For example, the clutch input may be provided by a side switch or pressure sensor positioned at one or more locations on the housing of computing device 12.

The user may press cancel input 104 whenever the parameter should no longer be adjusted. Screen 82 may also be formatted to facilitate use in a touch screen user interface 80. In other words, all of the user inputs may be large enough for a user to touch with a single finger. Alternatively, screen 82 may be formatted to include smaller user inputs when a pointing device may be used to select input buttons.

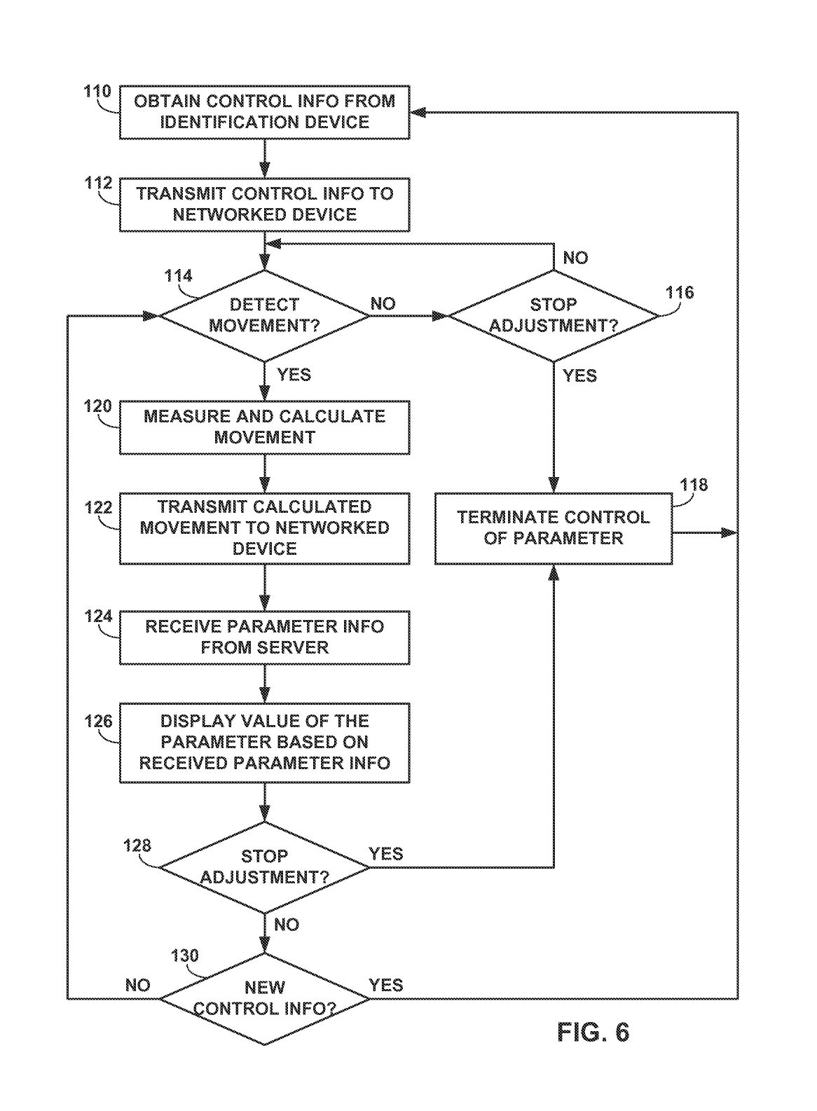

FIG. 6 is a flow diagram illustrating an example process that may be performed by computing device 12 to adjust a parameter value based on control information 26 from identification device 24 and detected movement of computing device 12. The process of FIG. 6 will be described below with respect to processor 40, but other processors, modules, applications, or any combination thereof, may perform the steps attributed to processor 40. Although the movement detection described in FIG. 6 is described with regard to accelerometer 53, other sensors such as compasses, gyroscopes, and optical sensors may be used instead to calculate the distance and direction computing device 12 has moved with respect to visual representation 110 and virtual controller 104. In addition, FIG. 6 is described with regard to identification device 24 being an NFC device. However, identification device 24 may be another short-range communication device or even a visual indicator or optical code including a bar code, QR code, or other image representative of control information 26.

Using short-range communication device 54 (e.g., an NFC device), processor 40 may obtain control information 26 from identification device 24 when computing device 12 is placed proximate to identification device 24 (110). Once processor 40 obtains the control information 26, processor 40 may transmit the control information to a network device such as remote server 18 via network 16 (112). Processor 40 may then start or continue to detect movement of computing device 12 (114). The operation of detecting movement may, in some examples, overlap with transmission of the control information to the network device and other operations such as receiving parameter information.

If processor 40 does not detect any movement of computing device 12 via accelerometer 53 (“NO” branch of block 114), processor 40 may determine if the adjustment of the parameter should be stopped (e.g., processor 40 has received input terminating control of the target device) (116). If the parameter adjustment is to be stopped (“YES” branch of block 116), processor 40 may terminate control of the parameter and the target device (118). If the parameter adjustment is to be continued (“NO” branch of block 116), processor 40 may continue to detect movement of computing device 12 (114).

If processor 40 detects movement of computing device 12 based on a change in output from accelerometer 53 (“YES” branch of block 114), processor 40 may measure accelerations of computing device 12 (120). Processor 40 may command accelerometer 53 to begin sensing accelerations or processor 40 may begin accessing accelerometer data to measure the accelerations. Using the acceleration values, processor 40 may calculate the distance computing device 12 has moved by double integrating the measured accelerations. Processor 40 may also calculate the direction computing device 12 has moved by determining the vector based on direction components of the distance values. Alternatively, processor 40 may calculate the direction of movement by taking a single integration of the acceleration values and using the velocity vector. Although this technique is described with regard to linear movement of computing device 12, rotational movement may similarly be detected as described herein.

Once the distance and direction of movement has been calculated, processor 40 may transmit the calculated distance and direction of computing device movement (e.g., movement information) to remote server 18 such that remote server can adjust the value of the parameter (122). Processor 40 may then receive the adjusted value of the control parameter from remote server 18 via network 16 (124). Once the adjusted value of the control parameter is received by computing device 12, processor 40 may display the adjusted value of the control parameter that is based on the transmitted movement information (126). For example, the adjusted value may be presented on screen 82 of FIG. 5.

If processor 40 receives a command to stop the adjustment of the parameter (“YES” branch of block 128), processor 40 may terminate the control of the parameter and the target device (118). Terminating control of the parameter may, in some examples, include transmitting a command to remote server 18 to terminate adjustment of the control parameter. If processor 40 does not receive a command to stop adjusting the parameter value (“NO” branch of block 128), processor 40 may check to determine if any new control information is to be obtained (130). If processor 40 determines that there is no new control information (“NO” branch of block 130), processor 40 may continue to detect movement (114). If processor 40 determines that there is new position information to obtain (“YES” branch of block 130), processor 40 may subsequently obtain control information from an identification device (110).

Generally, remote server 18 is described as communicating with target device 22 via network 16 to adjust the parameter value based on the detected movement of computing device 12. In other examples, remote server 18 may communicate with target device 22 via a different network or using a direct communication pathway other than a network. Alternatively, computing device 12 may directly control target device 22 (e.g., adjust the parameter based on physical movements of computing device 12). Computing device 12 may transmit adjustments to the parameter value via network 16. In other examples, computing device 12 may use infrared communication, radio frequency communication, or other direct communication protocol to adjust the value of the parameter based on control information 26 and the detected movement of computing device 12.

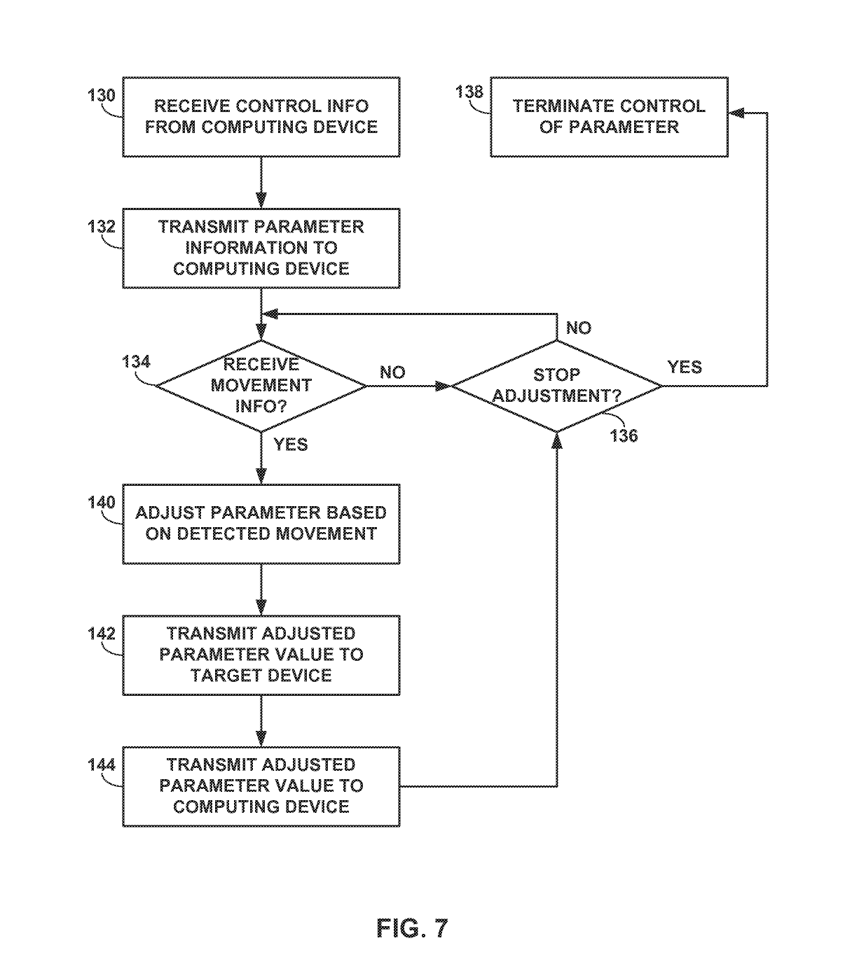

FIG. 7 is a flow diagram illustrating an example process that may be performed by remote server 18 to adjust a parameter of target device 22 based on control information 26 and movement information received from computing device 12. The process of FIG. 7 will be described with respect to a processor of remote server 18. However, other components of remote server 18 may perform similar functions in other examples. For example, remote server 18 may be controlled by multiple processors, or remote server 18 may be a compilation of two or more severs.

The processor of remote server 18 may receive control information 26 from computing device 12 via network 16 (130). The processor may retrieve parameter information associated with control information 26 from remote database 20 and/or target device 22. The processor may then transmit the parameter information to computing device 12 via network 16 (132). As described herein, the parameter information may include the type of parameter, the specific target device 22, which movements adjust the parameter, and the current parameter value for target device 22. If the processor does not receive movement information from computing device 12 (“NO” branch of block 134), the processor may determine if any command or elapsed time period has been received to stop the adjustment of the parameter (136). If the processor determines that no command has been received to stop the adjustment (“NO” branch of block 136), the processor may again receive movement information. If the processor determines that the parameter is no longer to be adjusted (“YES” branch of block 136), the processor for remote server 18 may terminate control of the parameter (138).

Once the processor receives movement information from computing device 12 (“YES” branch of block 134), processor adjusts the parameter value based on the detected movement of the movement information (140). The processor of remote server 18 may then transmit the adjusted parameter value to target device 22 (142). In addition, the processor of remote server 18 may transmit the adjusted value to computing device 12 in the form of parameter information (144). The processor of remote server 18 may then determine if adjustments of the parameter are to continue prior to performing any further adjustments (136)

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media.

In some examples, a computer-readable storage medium may comprise non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects of the disclosure have been described. These and other embodiments are within the scope of the following claims.

1. A method comprising:
obtaining, by a computing device, control information from an identification device that is associated with a target device, wherein the control information identifies the target device and an adjustable parameter that at least partially defines operation of the target device;
detecting, with at least one sensor, physical movement of the computing device subsequent to obtaining the control information; and
transmitting, by the computing device, the control information and movement information to a networked device different than the target device, wherein the networked device is configured to adjust a value of the adjustable parameter of the target device based at least in part on a function of the movement information, and wherein the movement information comprises information that indicates the detected physical movement of the computing device.

2. The method of claim 1, wherein detecting the physical movement of the computing device comprises detecting a tilt angle between a first measurement and a second measurement of the at least one sensor, and wherein the tilt angle is representative of a rotation about an axis orthogonal to the computing device.

3. The method of claim 2, wherein detecting the tilt angle comprises measuring an orientation of the computing device with respect to gravity.

4. The method of claim 2, wherein detecting the tile angle comprises measuring an orientation of the computing device with respect to Earth's magnetic field.

5. The method of claim 2, wherein detecting the tilt angle comprises measuring an angular acceleration of the computing device.

6. The method of claim 1, wherein detecting the physical movement of the computing device comprises:
measuring one or more accelerations of the computing device; and
calculating a distance and direction that the computing device was moved between a first measurement and a second measurement.

7. The method of claim 6, further comprising:
receiving, by the computing device, a clutch input during the detection, wherein initiation of the clutch input defines the first measurement and termination of the clutch input defines the second measurement of the sensor.

8. The method of claim 1, wherein the detected movement relates to a magnitude change in the parameter.

9. The method of claim 1, wherein the adjustable parameter is one of a volume control, a channel control, a light intensity control, a temperature control, a motor control, a fan control, a timer, or a toggle control.

10. The method of claim 1, further comprising:
receiving, by the computing device, the adjusted value of the adjustable parameter based on a function of the movement information; and
presenting, by a display of the computing device, a representation of the adjusted value of the adjustable parameter.

11. The method of claim 1, further comprising:
delivering, by the computing device, an audio feedback to a user based on a magnitude of the detected physical movement.

12. The method of claim 1, wherein obtaining the control information from the identification device comprises obtaining the control information via near field communication.

13. The method of claim 1, wherein the identification device comprises an optical code.

14. The method of claim 1, wherein the identification device is associated with a visual representation of the adjustable parameter.

15. The method of claim 1, wherein:
the control information comprises a uniform resource locator configured to direct a browser of the computing device to a web-based service associated with the networked device; and
the uniform resource locator comprises a code that identifies the adjustable parameter and the target device.

16. The method of claim 1, further comprising:
launching, by the computing device, a control application in response to obtaining the control information, wherein the control application at least partially controls detecting the physical movement of the computing device and transmitting the control information to the networked device; and
terminating the control application in response to receiving at least one of a termination input or a loss of communication with the identification device.

17. The method of claim 1, wherein the computing device, the identification device, and the target device are each different devices.

18. The method of claim 1, wherein the computing device is a mobile device.

19. A computer-readable storage medium encoded with instructions that cause one or more processors of a computing device to perform operations comprising:
obtaining control information from an identification device that is associated with a target device, wherein the control information identifies the target device and an adjustable parameter that at least partially defines operation of the target device;
detecting physical movement of the computing device subsequent to obtaining the control information; and
transmitting the control information and movement information to a networked device different than the target device, wherein the networked device is configured to adjust a value of the adjustable parameter of the target device based at least in part on a function of the movement information, and wherein the movement information comprises information that indicates the detected physical movement of the computing device.

20. A computing device comprising:
a near-field communication module configured to obtain control information from an identification device that is associated with a target device, wherein the control information identifies the target device and an adjustable parameter that at least partially defines operation of the target device;
a sensor configured to detect physical movement of the computing device subsequent to obtaining the control information; and
at least one processor configured to transmit the control information and movement information to a networked device different than the target device, wherein the networked device is configured to adjust a value of the adjustable parameter of the target device based at least in part on a function of the movement information, and wherein the movement information comprises information that indicates the detected physical movement of the computing device.
